(19) United States
(12) Patent Application Publication
(10) Pub. No.: US 2004/0175034 A1
(43) Pub. Date: Sep. 9, 2004

(54) Method for segmentation of digital images

(76) Inventors: Rafael Wiemker, Kisdorf (DE); Vladimir Pekar, Hamburg (DE)

Correspondence Address: Thomas M Lundin, Philips Intellectual Property & Standards, 595 Miner Road, Cleveland, OH, 44143, US

(21) Appl. No.: 10/481,810

(22) PCT Filed: Jun. 18, 2002
(86) PCT No.: PCT/IB02/02349

(30) Foreign Application Priority Data
Jun. 20, 2001 (EP) 01202391.7

(51) Int. Cl. G06K 9/34

(52) U.S. Cl. 382/173

(57) ABSTRACT

The invention relates to a computationally efficient method for the automated detection of intensity transitions in 2D or 3D image data. Contrasting boundaries in the image are indicated as global or local maxima of a gradient integral function, which is calculated by applying a Laplace operator to the intensity values of each pixel or voxel of the image data set. Only one pass through the image data set is required if the gradient integral function is computed by means of a cumulative histogram technique. The detected intensity thresholds can advantageously be employed for the specification of rendering parameters for visualization purposes. The method of the invention is also well-suited for the rendering and measurement of lung nodules, as the detection of correct intensity thresholds turns out to be crucial for the reproducible and consistent interpretation of medical image data.

The invention relates to a method for processing of digital images, wherein an automated segmentation is performed by determination of intensity threshold values, which separate at least one image object from the surrounding background of a digital image, said intensity threshold values being determined by evaluation of a gradient integral function.

Furthermore, the invention relates to a computer program for carrying out this method and to a video graphics appliance, particularly for a medical imaging apparatus, which operates in accordance with the present invention.

Efficient visualization techniques are becoming more and more important which is particularly due to the increasing amount of two- and three-dimensional image data being routinely acquired and processed in many scientific and technological fields. Optimal visualization of image data is of high importance for medical applications as it generally refers to the direct rendering of a diagnostic image, generated for example by computer tomography (CT) or magnetic resonance imaging (MRI), to show the characteristics of the interior of a solid object when displayed on a two dimensional display. In medical imaging either a planar or a volume image of a region of interest of a patient is reconstructed from the X-ray beam projections (CT) or the magnetic resonance signals (MRI). The resulting images consist of image intensity values at each point of a two- or three-dimensional grid. These data sets of equidistant pixels or voxels can be processed and displayed by appropriate methods for indicating the boundaries of various types of tissue corresponding to the intensity changes in the image data.

In order to display boundaries of anatomical structures, it is of particular importance to detect transitions between different tissue types in the image data. In surface rendering of volume image data sets for example, surface representations of the anatomical structures of interest are generated by binary classification of the voxels, which is achieved by the application of intensity threshold values for each tissue type transition. In volume rendering, tissue type transitions are evaluated when selecting the shape of a transfer function which assigns visualization properties, such as opacity and color, to intensity values of the rendered image.

One challenging problem in rendering of image data is the automated generation of data specific visualization parameters. Current visualization procedures widely involve human interaction, e.g. for the selection of appropriate transfer functions in volume rendering. In general, the user has to spicify the required parameters of the respective visualization protocol manually. The selection of the optimal parameters is performed by visually inspecting the resulting images. It is possible to interactively find optimal intensity threshold values corresponding to tissue transitions in this way, but since the result has to be assessed by visual inspection of the rendered images, this is generally a time consuming process. The manual method is particularly disadvantageous if volume rendering is performed, since the rendering process itself is computationally extremely demanding.

From the foregoing, it will be readily appreciated that there is a need for automated or at least semi-automated methods for the segmentation of digital images. Such a method is particularly advantageous in the field of medical imaging, since it immediately provides optimal threshold values for surface rendering and enables the automatic generation of opacity transfer functions for volume rendering.

A demand for automated image segmentation techniques is also due to the increasing importance of computer aided diagnosis (CAD), which is for example employed for the classification of lung nodules as either benign or malignant. The automated segmentation is necessary to enable the reproducible quantitative measurement of nodule properties, such as volume, eccentricity, growth etc. In comparison to manual segmentation of medical images, an automated segmentation method has the advantage of being much faster, thereby accelerating the work flow remarkably. It also delivers much more consistent and reliable results for the measurement of geometric properties in follow-up examinations and in patient-to-patient comparisons. Since lung cancer screening using computer tomography is more and more becoming a routine method, there is a need of powerful tools for automated segmentation and visualization of lung nodules. Such tools should enable the radiologist to perform the segmentation and visualization tasks more or less in real time, and they should be implementable on a clinical image processing workstation.

A method for automated segmentation of digital images has for example been proposed by Zhao et al. (“Two-dimensional multi-criterion segmentation of pulmonary nodules on helical CT images”, Zhao et al., Medical Physics, 26 (6), pp. 889-895, 1999). According to this known method, a series of intensity threshold values is first applied to the digital image. A binary image is generated for each of these thresholds by identifying all pixels with intensities being larger than the respective threshold intensity. Thereafter, the largest connected object is selected from the binary image, and the remaining image components are eliminated. In the next step, the boundaries of the object are traced, thereby calculating the mean intensity gradient strength at the object boundaries and the roundness of the object. These values depend on the respective intensity threshold. The computation is repeated for the series of threshold values, and finally the threshold, which corresponds to a large mean intensity gradient value and to an optimal roundness of the identified object, is selected.

The main drawback of this known method is that it takes a very long computation time. According to the above cited article, the proposed scheme takes several minutes to perform a standard segmentation task on a medical image processing workstation.

A further drawback is that the known method is only applicable if a single largest object can be found in the image data set. This is the typical situation if, for example, the segmentation is performed for the classification of a nodule during computer aided diagnosis of lung cancer. In these cases, a limited region of interest can be pre-defined by the user making sure that the examined lung nodule is the largest object of the image.

One particular object of the present invention is to improve the above described known method by making it computationally more efficient.

Furthermore, the general object of the present invention is to provide a method for the segmentation of digital images which is applicable for the automated detection of characteristic intensity transitions in the image data.

The present invention provides a method for the processing of digital images of the type specified above, wherein the aforementioned problems and drawbacks are avoided by computing said gradient integral as a function of threshold intensity by the steps of:

calculating a Laplacian for each point of said digital image, and

adding up said Laplacians for all points with intensities being larger than said threshold intensity.

The method of the invention enables the automated detection of intensity transitions representing, for example, the boundaries of anatomical structures in tomographic images. As in the above described known method, the task of detecting intensity transitions in the image data set is performed by the computation of an objective function. This is the gradient integral which is evaluated for determination of optimal intensity threshold values. The gradient integral is computed very efficiently in accordance with the method of the present invention by making use of the divergence theorem. A standard segmentation task can be performed in less than a second, because only a single computation pass of the image data set is required.

In the image data set, the intensity value at position x is I(x). Each intensity threshold Tᵢ generates a binary image consisting of pixels with intensity values being either larger or smaller than Tᵢ. Every binary image has a set of boundaries Γᵢ by which it is divided into regions with I(x)>Tᵢ and regions with I(x)<Tᵢ.

The basic problem is to find a set Γᵢ consisting of pixels or voxels with large intensity gradients \overline{V}I. In three dimensions, the gradient operator \overline{V} is \overline{V}=(∂/∂x, ∂/∂y, ∂/∂z)^{T}. Large intensity gradients indicate image stuctures with highly contrasted boundaries. Hence, the objective function for assessing the correctness of a segmentation can be defined as the integral of the gradient g=\overline{V}I over the set of boundaries Γᵢ:

F(Tᵢ)=∫_{T}_{ᵢ}|g|dγ

This integral can be computed for each threshold Tᵢ by finding the partitioning boundaries and computing the gradient vectors at the corresponding points. A threshold Tᵢ can be considered as optimal if the gradient integral F(Tᵢ) takes a maximum value.

According to the present invention, the computation of the integral gradient function is performed by the approach which is described as follows: The divergence theorem states that an intergral of a vector field g over the boundary surface Γ can be replaced by the volume integral of the divergence \overline{V}·g over the volume Ω enclosed by this surface. It can thus be easily shown that the gradient integral function can be written as:

F(T)=∫_{Ω}\overline{V}²Idω

This is because the divergence of the gradient vector field is equal to the Laplace operator \overline{V}²=(∂²/∂x², ∂²/∂y², ∂²/∂z²)^{T} applied to the intensity distribution of the image data. For the image data set consisting of discrete pixels or voxels, the correctness of the segmentation is computed by identifying all pixels or voxels with intensity values above the threshold T, and replacing the integral by adding up the respective Laplacians reading:

F(T)=Σ_{I(x)≧T}\overline{V}²I(x)

In accordance with claim 2, the Laplacian \overline{V}²I(x) can easily be calculated as the sum of the differences Δ=I(x)−I(x′) between the intensities of the point x and its respective neighboring points x′.

With the method of the present invention it is advantageous if the adding up of said Laplacians is performed by computing a histogram of said Laplacians as a function of image intensity and by further adding up all histogram values corresponding to intensities being larger than said threshold intensity.

The result is the above gradient integral which is computed for a plurality of thresholds Tᵢ at once. This scheme is particularly efficient, because only one pass through the image data set is required. At first, the histogram of Laplacians is computed. For this purpose, the Laplacians \overline{V}²I(x) are calculated at each point x of the image. The histogram is then incremented at bin I(x) by the value of the respective Laplacian. After the Laplacian values of all pixels or voxels have been inserted into the histogram, the histogram values are accumulated such that cumulative histogram values are set as the sum of all histogram values with I≧T. This directly corresponds to the computation of the sum F(T)=Σ_{I(x)≧T}\overline{V}²I(x) for the given threshold value T. Thus each cumulative histogram value gives a discrete approximation of the gradient integral over all pixels or voxels with I≧T.

With the method of the present invention some additional features of the segmented image can be computed, which are particularly useful for rendering of lung nodules and for quantitative measurement of their geometric properties. In this context, it is useful to further determine the intensity threshold values by evaluation of a “roundness function”, which is computed in accordance with the method of claim 5. The volume of the image objects can obviously be determined by simply counting the number of pixels or voxels with I≧T. The difference between the numbers of positive and negative signs of the Laplacians \overline{V}²I(x) taken for all positions x with I(x)≧T gives the number of boundary faces between the image objects and the surrounding background. The number of boundary faces is proportional to the total surface of the image objects. The “roundness” can be estimated by determining the ratio of the total volume and the total surface of the image objects. This volume-to-surface ratio takes a maximum if the image objects are mostly spherical.

Furthermore, a mean gradient function can be computed as the ratio of the gradient integral function and the respective number of surface points. For the automated segmentation of lung nodules, for example, the optimal threshold intensity value can be selected such that the mean gradient and the roundness are high at the same time.

For the computation of volume, surface, mean gradient and other functions of threshold intensity, it is advantageous to employ the above described technique of cumulative histograms as well. The histograms are set up as functions of image intensity, which always requires only a single pass through the image data set. The results can then be computed by accumulating the values of the corresponding bins of the histograms, which takes only a minimum amount of computation time.

Other features of the segmented image, which can be computed in accordance with the present invention, are for example the surface curvature and the surface fractality. For a voxel with a boundary face in x-direction, the curvature of this surface patch can be estimated as dC=|∂²/∂y²+∂²/∂z²| (for the y- and z-directions, the curvature is dC=|∂²/∂x²+∂²/∂z²| and dC=|∂²/∂x²+∂²/∂y²|, respectively). The curvature integral of the whole surface of the image objects can advantageously be calculated by the above cumulative histogram technique, so that a discrete approximation of the surface curvature C(T)=Σ_{I≧T}C(I) at threshold T is obtained. This technique can also be employed to compute the surface fractality by calculating the total surface area of the segmented image objects at different levels of subsampling of the image data. Thereafter, the fractal dimension of the surface at threshold T is assessed by linear regression of the logarithm of the surface area as a function of subsampling length. The computation of surface curvature and surface fractality as further criteria for evaluation of the most appropriate intensity threshold for the segmentation of the digital image takes only a minimum of additional computation time.

The method of the present invention can advantageously be applied for rendering of volume image data sets. In accordance with claims 7-10, a transfer function is employed which assigns visualization properties to image intensity values. For the visualization of the volume image, this transfer function is automatically generated such that it assigns different visualization properties to those voxels of said volume image data set which are separated by the intensity threshold values being prescribed by the method of the present invention. The transfer function can for example be generated such that it assigns a high opacity to those voxels that have intensities being larger than the respective threshold intensity, while the remaining parts of the image appear transparent. In this way, a change in image opacity can automatically be correlated with the intensity transitions of the rendered volume image data set.

A computer program adapted for carrying out the method of the present invention performs the processing of a volume image data set pursuant to claims 11-14. Such an algorithm can advantageously be implemented on any common computer hardware which is capable of standard computer graphics tasks. Especially image reconstruction and displaying units of medical imaging devices can easily be provided with a programming for carrying out the method of the present invention. The computer program can be provided for these devices on suitable data carriers as CD-ROM or diskette. Alternatively, it can also be downloaded by a user from an internet server.

It is also possible to incorporate the computer program of the present invention in dedicated graphics hardware componentes, as for example video cards for personal computers. This makes sense notably since a single CPU of a typical personal computer is usually not capable of carrying out volume rendering with interactive frame rates. The method of the present invention can for example be implemented into a volume rendering accelerator of a PCI video card for a conventional PC. Todays PCI hardware has the capacity and speed which is required for delivering interactive frame rates by use of the above described algorithm.

The following drawings disclose preferred embodiments of the present invention. It should be understood, however, that the drawings are designed for the purpose of illustration only and not as a definition of the limits of the invention.

In the drawings

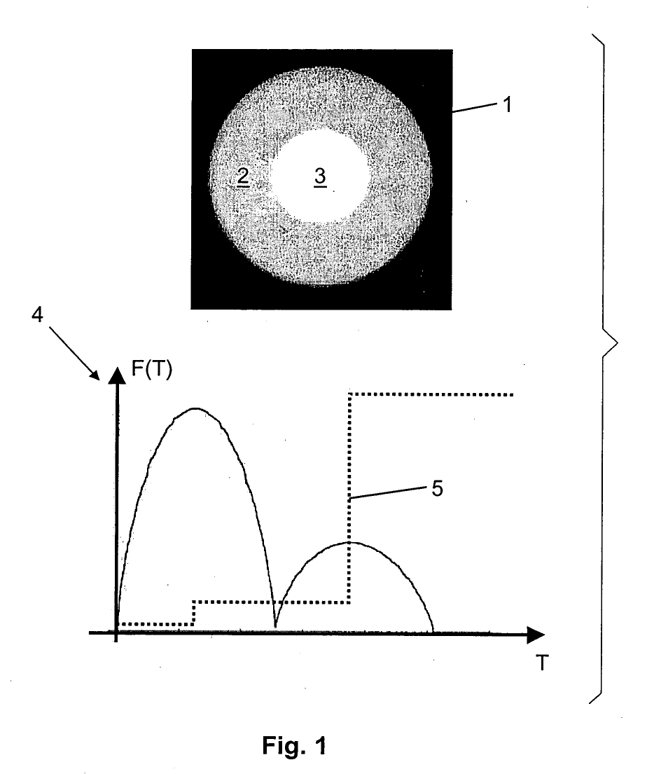

FIG. 1 shows the application of the method of the present invention for detecting intensity transitions in a synthetic image data set;

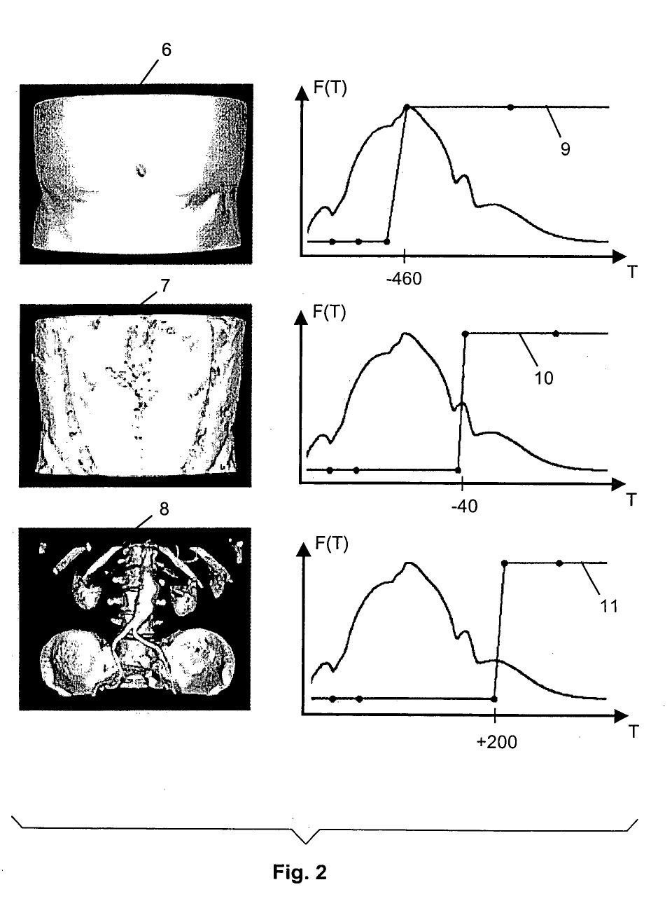

FIG. 2 shows the prescription of an opacity transfer function for volume rendering of an abdomen CT data set;

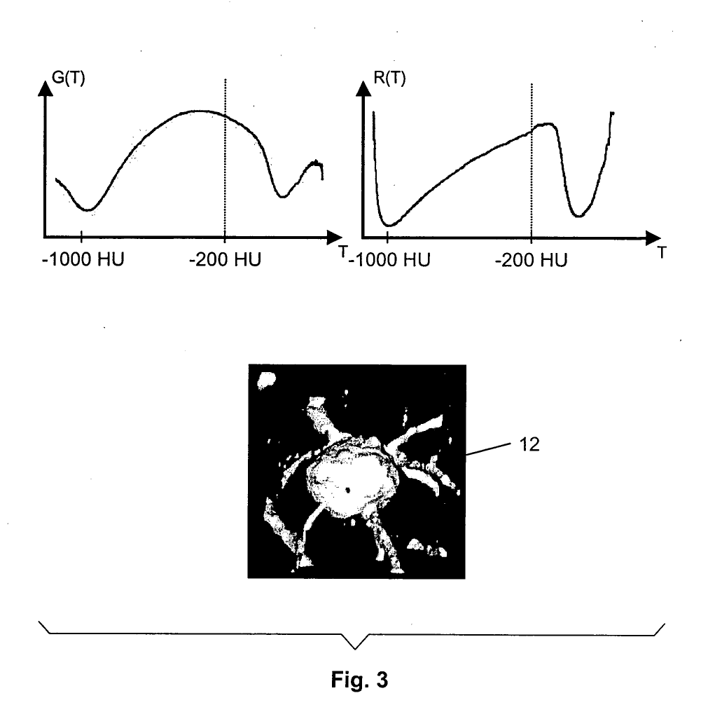

FIG. 3 shows the automated segmentation of a CT data set of a lung nodule by the method of the present invention.

FIG. 1 shows an example of the application of the method of the present invention for detecting intensity transitions between different material types in an image data set.

It will become apparent in the following, that the method of the invention can advantageously be incorporated into a rendering software of an image processing workstations such that intensity thresholds can be selected either manually by a user or automatically by evaluation of at least one of the above quality functions. For volume rendering, for example, the user adjusts the shape of the opacity transfer function in accordance with the curve of the respective goodness function. In this way, the method of the invention is assisting the user with the interactive specification of rendering parameters.

FIG. 1 shows an image 1 of a slice through a model data set. This artificial data set consists of a concentric arrangement of two different materials. As a model of a real CT data set, the image 1 shows a dark region 2 corresponding to soft tissue and a light region 3 corresponding to bone. FIG. 1 further shows a diagramatic representation 4 of the gradient integral function which is computed for the image 1 by the method of the present invention. The diagram 4 shows two clear maxima of the function F(T). These two maxima correspond to the transitions from background to soft tissue (left maximum) and from soft tissue to bone (right maximum). These two detected intensity transitions can be used for the manual or automated assignment of visualzation properties to data voxels. For the volume rendering of the image data set, the diagram 4 further shows a curve 5 representing the opacity transfer function, which has a two-step shape, such that the bone tissue is made completely opaque while the soft tissue appears transparent.

FIG. 2 shows the application of the method of the invention for the detection of intensity transitions in an abdomen CT data set. In FIG. 2, three volume rendered images 6, 7, 8 are shown on the left. The respective opacity transfer functions 9, 10, 11, which are used for the rendering of the data set, are displayed next to the respective images on the right. In the diagrams, the opacity transfer functions are overlaid on top of the gradient integral F(T) of the CT data set. The gradient integral function F(T) shows well-pronounced peaks at the transitions air to skin, skin to muscle and soft-tissue to bone. In the upper image, the opacity transfer function has a step at −460 HU (Hounsfield units), such that the complete body appears opaque while the surrounding air is made fully transparent. It can be seen in FIG. 2 that the gradient integral takes its global maximum at this intensity value, thereby indicating the most dominant contrast of the data set. A local maximum of the gradient integral is found at −40 HU. This threshold is selected to visualize the skin to muscle transition in image 7 of FIG. 2. The local maximum at +200 HU is used to separate the anatomical structures of the bones from the remaining soft tissue in the lower image 8.

FIG. 3 shows the application of the method of the invention for the segmentation of a CT image of a lung nodule. When the radiologist finds a suspicious object on a CT image of the lung, he selects a volume of interest (VOI) closely around this object. The next step is the automated segmentation of the VOI in order to classify each voxel as either belonging to the background (the lung parenchyma) or to the foreground (the nodule). Again, the decisive parameter is the correct intensity threshold T, which is efficiently computed by the method of the present invention. Once the separating threshold is known, it can be utilized for rendering or for the measurement of nodule properties. FIG. 3 shows an image 12 of a single nodule in a cube-shaped VOI. The dimensions of the cube are 30×30×30 mm³ (125000 voxels). The threshold for the rendering is chosen such that the mean gradient integral G(T) and the sphericity R(T) are high at the same time, which is obviously the case at a Hounsfield level of −200 HU. As described above, the mean gradient is the ratio of the gradient integral and the total surface of the object volume with I>T. The gradient integral and the surface area are computed by the method of the present invention. R(T) is computed as the ratio of the volume of the image object and a further spherical volume. The latter volume is estimated as the volume of a sphere, wherein the radius of the sphere is taken as the square root of the surface area of the segmented image object. This sphericity function takes a maximum if the shape of the image object is mostly spherical.

1. Method for processing of digital images, wherein an automated segmentation is performed by determination of intensity threshold values, which separate at least one image object from the surrounding background of a digital image, said intensity threshold values being determined by evaluation of a gradient integral function, characterized in that said gradient integral is computed as a function of threshold intensity by the steps of:
calculating a Laplacian for each point of said digital image, and
adding up said Laplacians for all points with intensities being larger than said threshold intensity.

2. Method of claim 1, characterized in that said Laplacian is calculated for each point by computing the sum of differences between the intensities of this point and its respective neighboring points.

3. Method of claim 1, characterized in that said adding up of said Laplacians is performed by computing a histogram of said Laplacians as a function of image intensity and by further adding up all histogram values corresponding to intensities being larger than said threshold intensity.

4. Method of claim 1, characterized in that the number of surface points of said image objects is determined by computing the difference between the numbers of positive and negative signs of said Laplacians for all points of said digital image with intensities being larger than said threshold intensity.

5. Method of claim 4, characterized in that said intensity threshold values are further determined by evaluation of a roundness function, wherein said roundness is computed as a function of threshold intensity by the steps of:
calculating the volume of said image objects by determining the number of points of said digital image with intensities being larger than said threshold intensity, and
computing the ratio of said volume and said number of surface points.

6. Method of claim 4, characterized in that the surface fractality of said image objects is determined by computing the number of surface points at different levels of spatial subsampling of the image data.

7. Method for rendering of a volume image data set on a two-dimensional display, wherein a transfer function is employed which assigns visualization properties to image intensity values, characterized in that said transfer function is automatically generated such that it assigns different visualization properties to those voxels of said volume image data set which are separated by intensity threshold values being computed in accordance with the method of claim 1.

8. Method of claim 7, characterized in that said intensity threshold values are selected such that said gradient integral function takes a maximum at these values.

9. Method for rendering of a pre-defined region of interest of a volume image data set on a two-dimensional display, wherein a transfer function is employed which assigns visualization properties to image intensity values, characterized in that said transfer function is automatically generated such that it assigns different visualization properties to those voxels of said volume image data set which are separated by an intensity threshold value being computed in accordance with the method of claim S.

10. Method of claim 9, characterized in that said intensity threshold values are selected such that a mean gradient function, which is computed as the ratio of said gradient integral function and said number of surface points, and said roundness function are maximized simultaneously.

11. Computer program for carrying out the method of claim 1, characterized in that the processing of a volume image data set comprises the steps of:
calculating a Laplacian for each voxel,
computing gradient integrals for a plurality of threshold intensity values such that each gradient integral is set as the sum of Laplacians of all voxels with intensities being larger than the respective threshold intensity, and
selecting at least one of said plurality of threshold intensity values such that the corresponding gradient integral takes a maximum at this value.

12. Computer program for carrying out the method of claim 5, characterized in that the processing of a volume image data set comprises the steps of:
calculating a Laplacian for each voxel,
computing object volumes for said plurality of threshold intensity values such that each object volume is set as the number of voxels with intensities being larger than the respective threshold intensity,
computing object surface values for said plurality of threshold intensity values such that each object surface value is set as the difference between the numbers of positive and negative signs of said Laplacians for all voxels with intensities being larger the respective threshold intensity, and
calculating a mean roundness by computing the ratios of said object volumes and said object surface values for each of said plurality of threshold intensity values.

13. Computer program of claim 12, characterized in that it further comprises the steps of:
computing gradient integrals for a plurality of threshold intensity values such that each gradient integral is set as the sum of Laplacians of all voxels with intensities being larger than the respective threshold intensity,
computing mean gradients by calculating the ratios of said gradient integrals and said object surface values for each of said plurality of threshold intensity values, and
selecting at least one of said plurality of threshold intensity values such that the corresponding mean gradient and the correponding roundness value take a maximum at this value.

14. Video graphics appliance, particularly for a medical imaging apparatus, with a program controlled processing element, characterized in that the graphics appliance has a programming which operates in accordance with the method of claim 1.
